(19) United States
(12) Patent Application Publication
(10) Pub. No.: US 2012/0235518 A1
(43) Pub. Date: Sep. 20, 2012

(54) Oscillating Motor Adjuster

(75) Inventors: Florian Hentsch, Wendlingen (DE); Andrea Moll, Wendlingen (DE); Dirk Pohl, Kirchentellinsfurt (DE)

(73) Assignee: Hilite Germany GmbH, Marktheidenfeld (DE)

(21) Appl. No.: 13/417,440

(22) Filed: Mar. 12, 2012

(30) Foreign Application Priority Data
Mar. 16, 2011 (DE) 10 2011 001 301

(51) Int. Cl. H02K 7/06

(52) U.S. Cl. 310/37

(57) ABSTRACT

The invention relates to an oscillating motor adjuster having a driven stator, which is followed by a first rotor via a first hydraulic power transmission path, which is followed by a second rotor via a second hydraulic power transmission path. The second rotor is joined in a torsionally rigid manner to a second camshaft part, which is disposed coaxially to a first camshaft part, which is joined in a torsionally rigid manner to the first rotor. The relative angular position of the two rotors to one another can be adjusted very accurately by this sequential arrangement of the two rotors.

This application claims the benefit of German patent application number DE 10 2011 001 301.6 filed on Mar. 16, 2011, which is incorporated herein by reference in its entirety and for all purposes.

### BACKGROUND OF THE INVENTION

The present invention relates to an oscillating motor adjuster for a two-part camshaft. Oscillating motor adjusters for adjusting two-part camshafts are known from DE 36 248 27 A1, DE 10 2005 014 680 A1, DE 10 2006 041 918 A1, and U.S. Pat. No. 6,725,817 B2.

DE 100 45 416 B4 relates to an oscillating motor adjuster in which a pin of a housing is plugged into a central recess of the rotor. Thus, the rotor of the oscillating motor adjuster is disposed in a rotatable manner relative to the pin that is stationary in the housing. Oil can be introduced from a 4/3-way hydraulic valve into the oscillating motor adjuster via channels in the housing and in the pin, so that the rotor can be pivoted or oscillated into two opposite oscillating directions relative to a stator.

Unpublished DE 10 2011 000 650.8 relates to an oscillating motor adjuster in which oil is introduced from a housing radially outside into a stator of the oscillating motor adjuster.

### SUMMARY OF THE INVENTION

The object of the present invention is to create an oscillating motor adjuster that makes possible an adjustment of a two-part camshaft having an inner shaft and an outer shaft.

This object is achieved in accordance with the embodiments of the present invention disclosed herein.

According to the present invention, two rotors are disposed sequentially to one another. That is, a first rotor follows the stator driven by a crankshaft via a first hydraulic power transmission path, while a second rotor follows via a second hydraulic power transmission path. In this case, the first rotor is joined resistant to rotation to the first camshaft part, while on the other hand, the second rotor is joined resistant to rotation to the second camshaft part. The two camshaft parts are disposed coaxially to one another.

The sequential oscillating motor adjuster according to the present invention has the advantage that the second rotor is directly dependent on the first rotor in its manufacturing tolerances or in its angular position. In this way, two tolerances need not be taken into consideration for the relative angular position of the two rotors, but rather only one tolerance. Therefore, the relative angular position of the two rotors to one another can be adjusted very accurately.

Another advantage provided by the present invention is that the sequential oscillating motor adjuster according to the invention makes possible a very rapid adjustment. Thus, the inner rotor is necessarily very small for the given installation conditions. A small rotor means a small oil volume in the pressure chambers, which is accompanied by a very rapid adjustment. The disadvantage associated with a small rotor in the prior art is that the friction component is greater, but this plays no role in the oscillating motor adjuster according to the invention. That is, the inner rotor has a very small basic friction, since part of the adjustment for loads takes place in the radially outer (i.e., first) rotor.

The two parts of the camshaft can be designed as a hollow shaft and an inner shaft disposed within the latter. The use of a central screw without a central valve disposed within this central screw makes it possible to brace the central screw in the small cross section of the inner shaft strongly enough that sufficient torque can be transmitted.

In one example embodiment of the present invention, a housing is provided, which can be, in particular, a housing rigidly joined with the cylinder head or a housing part of a cylinder head cap or the cylinder head itself. The stator is mounted in a rotatable manner in a housing borehole of this housing. Oil can be introduced by means of annular grooves in a stator outer wall having oil boreholes or oil channels exiting from these annular grooves into pressure chambers assigned to opposite oscillating directions. In this case, preferably a separate oil borehole or a separate oil channel, which introduces the oil, is allotted to each pressure chamber. This makes possible an integration of the rotary leadthrough into the stator, which, in contrast, is designed separately in the prior art. The radial dimensions of the oscillating motor adjuster can be small. Also, the axial structural space can be short. In this way, the oscillating motor adjuster will be very small. An oil feed via the camshaft is not necessary, so that the camshaft need not be weakened by means of cross boreholes.

When compared with an oil supply via the camshaft or a camshaft bearing, the hydraulic paths are very short, so that hydraulic losses are also small. This is then particularly advantageous when camshaft alternating torques are utilized for a more rapid adjustment of the camshaft. Additional boreholes in the rotor hub are not absolutely necessary. In a particularly advantageous manner, dirt particles are pressed radially outward from the pressure chambers as a consequence of centrifugal force.

Additional advantages of the invention are derived from the patent claims, the description and the drawing.

### BRIEF DESCRIPTION OF THE DRAWINGS

The present invention will hereinafter be described in conjunction with the appended drawing figures, wherein like reference numerals denote like elements, and:

FIG. 1 shows an example embodiment of an oscillating motor adjuster in accordance with the present invention in a section along a longitudinal axis.

FIG. 2 shows the oscillating motor adjuster of FIG. 1 in a section along line II-II of FIG. 1; and

FIG. 3 shows the oscillating motor adjuster of FIG. 1 in a view without a cover plate and without a housing.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

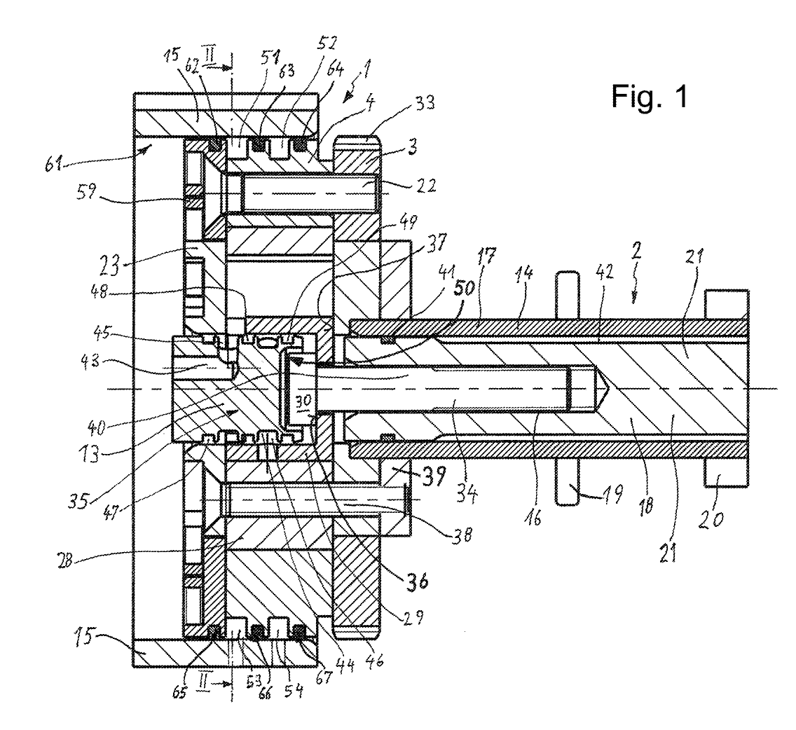

The angular position of a two-part camshaft 2 can be continuously changed relative to a drive wheel 3 during the operation of an internal combustion engine by an oscillating motor adjuster 1 according to FIG. 1. By rotating camshaft 2, the opening and closing time points of the gas exchange valves are shifted so that the internal combustion engine offers its optimal performance at the rpm involved. In this case, a radially outer camshaft part 17 designed as a hollow shaft 14 is joined with first cams 19, 20 for control of the gas exchange valves. For this purpose, cams 19, 20 are shrunk-fit onto the radially outer camshaft part 17, for which an additional micro-gearing can be provided. A radially inner camshaft part 18, which is designed as a solid shaft 21, is also joined to cams, which are not shown in further detail. These cams, which are not shown in further detail, however, are joined via a pin connection to the radially inner camshaft part 18 and mounted on the radially outer camshaft part 17. Such a pin connection has already been presented in DE 10 2005 014 680 A1, to which reference is made herewith.

The oscillating motor adjuster 1 has a stator 4, which is joined in a torsionally rigid manner to drive wheel 3. For this purpose, a screw connection is provided, which has several screws 22. These screws 22 brace a stator 4 between a cover plate 23 and drive wheel 3. Drive wheel 3 is a chain wheel with a gearing 33, over which a chain, which is not shown in more detail, is guided as the drive element. Stator 4 is drive-connected to the crankshaft by means of this drive element and drive wheel 3.

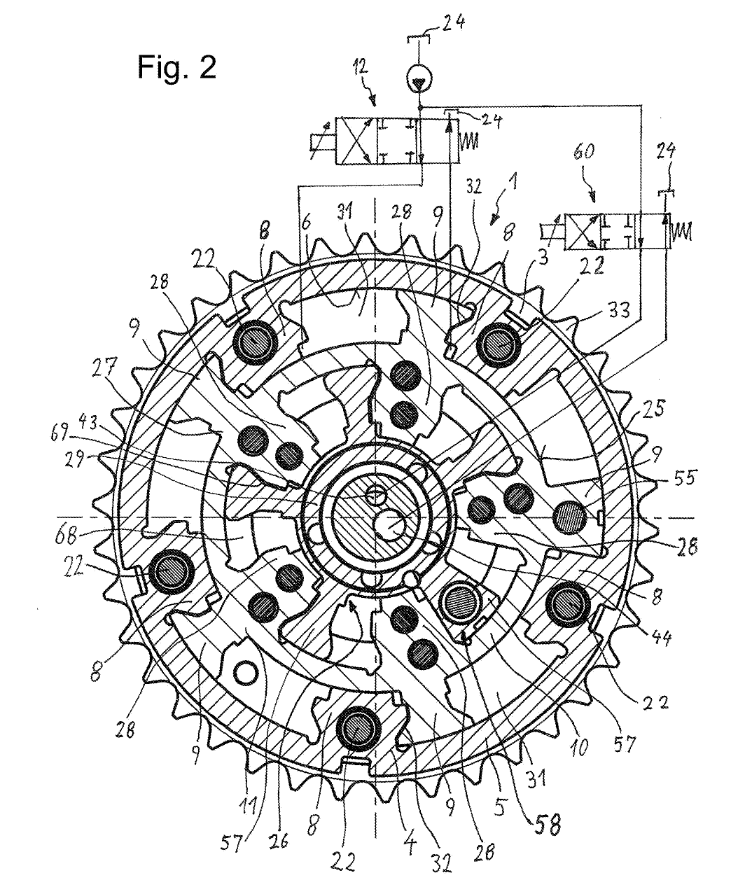

Stator 4 also comprises a cylindrical stator outer wall 5, which is visible in FIG. 2, and crosspieces 8 project radially inward at equal distances from the inner side of this wall. Between adjacent crosspieces 8, intermediate spaces are formed, into which oil is introduced as a pressure medium. For this purpose, a first proportional 4/3-way hydraulic valve 12 is provided, which is explained further below and which correspondingly controls the pressure medium.

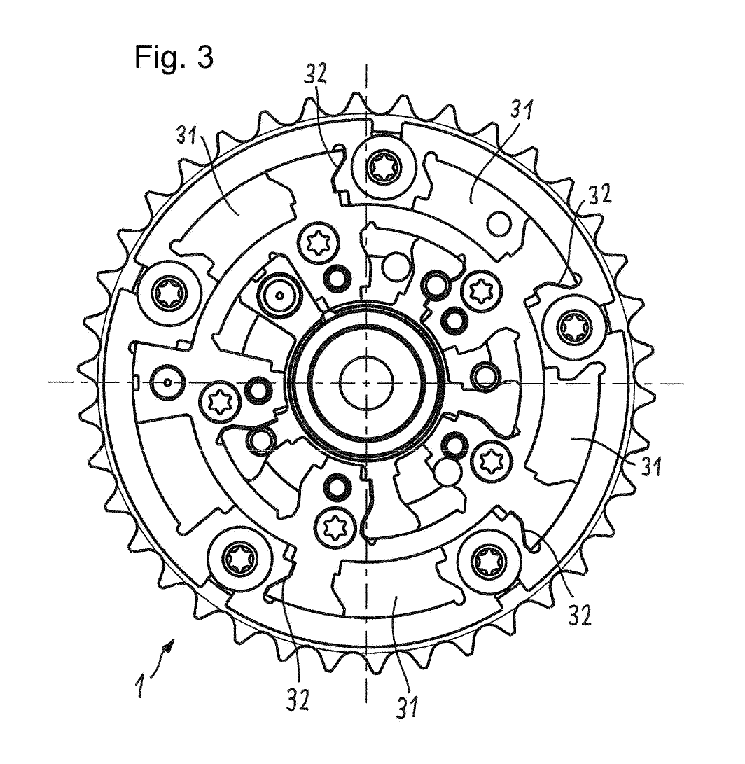

Vanes 9, which protrude radially toward the outside from a cylindrical housing wall 10 of an intermediate rotor 11, project between adjacent crosspieces 8. These vanes 9 subdivide the intermediate spaces between crosspieces 8 each time into two pressure chambers 31, 32, of which pressure chambers 32 in FIG. 2 and FIG. 3 are reduced to a minimum. In the position of the first proportional 4/3-way hydraulic valve 12, which is shown in FIG. 2, pressure chambers 31 are loaded with hydraulic pressure, while in contrast, pressure chambers 32 are relieved of pressure toward a tank 24.

Crosspieces 8 are applied tightly by their front sides to the outer surface 25 of housing wall 10. Vanes 9 in turn are applied tightly by their front sides to the cylindrical inner wall 6 of stator outer wall 5.

Intermediate rotor 11 takes over the function of an inner stator 27 for an inner rotor 26. For this purpose, radially inwardly directed inner crosspieces 28 project at equal distances from housing wall 10 of intermediate rotor 11 on its inner side. Intermediate spaces are formed between adjacent inner crosspieces 28. Inner rotor 26 separates these intermediate spaces each time into a first pressure chamber 68 and a second pressure chamber 69 assigned to opposite oscillating directions. As the pressure medium, oil can be introduced into or discharged from the two pressure chambers 68, 69. For this purpose, a second proportional 4/3-way hydraulic valve 60 is provided, which is explained further below and which correspondingly controls the oil as the pressure medium.

The inner rotor 26 is disposed so that it can oscillate inside intermediate rotor 11 and is joined in a torsionally rigid manner to the inner camshaft part 18 of camshaft 2 by means of a central screw 34 that is visible in FIG. 1. For this purpose, this central screw 34 is plugged into camshaft 2 through a central recess 35 of a rotor hub 29 of inner rotor 26 and screwed with an inner thread 16 of inner camshaft part 18. In this case, a screw head 30 of central screw 34 is applied to a base 36 of central recess 35 and thus braces drive wheel 3 against a front side 37 of hollow shaft 14, which forms the outer camshaft part 17. Drive wheel 3 is rigidly screwed to stator 4 and cover plate 23 by means of screws 22. Additional screws 38 produce a solid connection between intermediate rotor 11 and a plate 39, which is mounted coaxially to hollow shaft 14 and is applied to drive wheel 3. In this way, screws 38 produce a torsionally rigid connection to hollow shaft 14. This torsionally rigid connection is a flange joint.

The inner camshaft part 18 has a blind borehole 40 in which inner thread 16 is cut. On the side turned toward oscillating motor adjuster 1, inner camshaft part 18 is sealed relative to hollow shaft 17 by means of an O-ring 41. In order to minimize friction, inner camshaft part 18 has an annular gap 42 relative to hollow shaft 14.

A pin-shaped component 13, which is pressed into a housing 15 in a way that is not shown in detail, is provided inside the recess 35, this pin-shaped component 13 having an A1 channel 43 that conducts oil to one of the pressure chambers. Separate from this A1 channel 43, a B1 channel 44 is provided, which conducts oil to the other pressure chamber. Pin-shaped component 13, which is fixed in the housing, is inserted into the only partially shown housing 15, which is joined resistant to movement to the cylinder head, which is not shown in more detail. Pin-shaped component 13 has two annular channels 45, 46 surrounding the component 13 in ring-shaped manner. Al channel 43 opens up into one annular channel 45. B1 channel 44 opens up into the other annular channel 46. Sealing rings that are axially adjacent to the two annular channels 45, 46 are inserted into annular grooves 47, 48, 49. In this case, only one common sealing ring is disposed axially in annular groove 48 between the two annular channels 45, 46. Since in these sealing rings a continuous rotational movement takes place on the respective sealing ring, these sealing rings, which are not shown in the drawing, are designed correspondingly as insensitive to sliding friction On the front side turned toward camshaft 2, the pin-shaped component 13 is designed with a recess 50, inside of which screw head 30 extends, so that the oscillating motor adjuster 1 can be built having a very short length.

On its outer periphery, stator 4 also has two annular channels 51, 52 axially distanced from one another. The annular channel 51 bounded by cover plate 23 is assigned to an A2 channel 53, which conducts oil from housing 15 to one of the pressure chambers. The annular channel 52, which is placed closer to drive wheel 3, in contrast, is assigned to a B2 channel 54, which conducts oil from housing 15 to the other pressure chamber.

A first lock 55 is provided in one vane of vanes 9, with which the intermediate rotor 11 can be attached in form-fitting manner to stator 4. One vane of vanes 57 of inner rotor 26 has a second lock 58, with which the inner rotor 26 can be attached to intermediate rotor 11.

Cover plate 23 has a spiral-shaped compensation spring 59 on its side facing away from camshaft 2. This compensation spring 59 attempts to keep inner rotor 26 at a specific angular position relative to stator 4.

In this case, the A2 channel 53 is assigned to a first working port A, while in contrast, the B2 channel 54 is assigned to a second working port B.

Housing 15 has a large housing borehole 61, in which stator 4 is mounted in a rotatable manner. In order to keep leakage losses as small as possible, sealing rings 62, 63, 64 are provided. These sealing rings 62, 63, 64 are inserted into annular grooves 65, 66, 67, which are disposed axially distant from the A2 channel 52 and the B2 channel 54. In this way, the middle sealing ring 63 is disposed axially in annular groove 66 between the A2 channel 52 and the B2 channel 54. The two axially outer sealing rings 62, 64 seal annular groove 65 and/or annular groove 67 toward the outside.

The two proportional 4/3-way hydraulic valves 12, 60 have a locking center position. The two proportional 4/3-way hydraulic valves 12, 60 are supplied with oil pressure by a common oil pump. A holding pressure for intermediate rotor 11 and inner rotor 26 is produced by means of a run-off edge control as has already been described in DE 198 23 619 A1. Control of the 4/3-way hydraulic valves 12, 60 is produced electromagnetically. Both 4/3-way hydraulic valves 12, 60 are disposed in a decentralized manner, i.e., not coaxially to an axis of rotation 56 of the oscillating motor adjuster.

In an alternative example embodiment of the invention, it is also possible to dispose the 4/3-way hydraulic valve assigned to inner rotor 26 as a central valve inside rotor hub 29.

The closer the respective 4/3-way hydraulic valve 12 or 60 is disposed relative to intermediate rotor 11 or rotor 26 to be adjusted, the more it lends itself to provide a system for utilizing the camshaft alternating torques in the respective 4/3-way hydraulic valve 12 or 60. Such a system for utilizing camshaft alternating torques is known from DE 10 2006 012 733 B4.

In an alternative example embodiment, the drive wheel is a toothed belt gear, over which a drive belt is guided as a drive element.

Basically, sintered steel, plastic or light metal are considered as materials for the various parts of the motor adjuster, including the rotors, drive wheel, stator, cover plate, and the like. Steel sheet material may also be used for the cover plate, the drive wheel or the like where only thin walls are required. A plastic, in particular, can be a duroplast with mineral powder inclusions and fiber inclusions. A light metal, in particular, can be aluminum or magnesium.

In another alternative example embodiment of the present invention, the oil may be guided via a camshaft bearing and the camshaft to the working ports in the oscillating motor adjuster. Such a camshaft comprising an inner shaft and an outer shaft with hydraulic pressure supply via a camshaft bearing and a central valve in the camshaft adjuster is already known from DE 10 2006 024 793 A1, to which reference is made herewith. In contrast to this, a decentralized valve, which introduces hydraulic pressure into the camshaft adjuster via channels in the camshaft bearing, is provided in the case of DE 10 2006 028 611 A1.

The internal combustion engine can be either a gasoline engine or a diesel engine.

For the sealing rings on the pin-shaped component 13 or on the stator 4, sealing rings that permit a permanent tightness in the case of rotation can be provided. In addition to plastic, metal can also be used here as a material.

The pin-shaped component 13 need not be stationary relative to the rotating inner rotor 26. It is also possible that this component rotates with the rotor 26 and, in fact, is made up in one piece with it. In this case, for example, the pin-shaped component 13 can extend from the rotor and the camshaft and be mounted in a rotatable manner in housing 15. The oil can then be transferred again via annular grooves that are disposed in housing 15 or on the pin-shaped component 13. The arrangement of the annular grooves on the pin-shaped component 13 has the advantage that an outer processing is more cost-effective than an unscrewing from inner annular grooves from a borehole in housing 15.

It is also possible to provide a central valve instead of the pin-shaped component 13. This central valve can be plugged into the rotor hub from the outside, i.e., the side facing away from the camshaft. This central valve may also be designed as a central screw and thus assumes the function of central screw 34.

The oil inlet shown in the drawing for inner rotor 26 is also called a front-side oil supply, which is contrasted to the oil supply of the outer rotor on the outer periphery.

The inner camshaft part that is designed as a solid shaft in the example embodiment may also be designed as a hollow shaft. DE 10 2006 013 829 A1 shows such an inner camshaft part designed as a hollow shaft.

The above-described embodiments only involve exemplary configurations. A combination of the described features for different embodiments is also possible. Additional features, particularly those which have not been described, for the device parts belonging to the invention can be derived from the geometries of the device parts shown in the drawings.

### LIST OF REFERENCE CHARACTERS

1 Oscillating motor adjuster

### 2 Camshaft

3 Drive wheel

### 4 Stator

5 Outer wall of the stator
6 Inner wall

### 8 Crosspieces

### 9 Vane(s)

10 Housing wall
11 Intermediate rotor
12 4/3-Way hydraulic valve
13 Pin-shaped component
14 Hollow shaft

### 15 Housing

16 Inner thread
17 Radially outer camshaft part
18 Radially inner camshaft part

### 19 Cam

### 20 Cam

21 Solid shaft

### 22 Screws

23 Cover plate

### 24 Tank

25 Outer surface
26 Inner rotor
27 Inner stator
28 Inner crosspieces

### 29 Rotor hub

30 Screw head
31 Pressure chambers
32 Pressure chambers

### 33 Gearing

34 Central screws
35 Central recess

### 36 Base

37 Front side
38 Additional screws

### 39 Plate

40 Blind borehole

### 41 O-ring

### 42 Annular gap

43 A1 channel
44 B1 channel
45 Annular channel
46 Annular channel
47 Annular groove
48 Annular groove
49 Annular groove

### 50 Recess

51 Annular channel
52 Annular channel
53 A2 channel
54 B2 channel
55 First lock
56 Axis of rotation

### 57 Vane(s)

58 Second lock
59 Compensation spring
60 4/3-Way hydraulic valve
61 Housing borehole
62 Sealing ring
63 Sealing ring
64 Sealing ring
65 Annular groove
66 Annular groove
67 Annular groove
68 Pressure chambers
69 Pressure chambers

What is claimed is:

1. An oscillating motor adjuster, comprising:
a driven stator,
a first rotor joined in a torsionally rigid manner to a first camshaft part of a camshaft,
a second rotor joined in a torsionally rigid manner to a second camshaft part of the camshaft, the second camshaft part being disposed coaxially to the first camshaft part,
wherein:
the stator is followed by the first rotor via a first hydraulic power transmission path, and
the first rotor is followed by the second rotor via a second hydraulic power transmission path.

2. The oscillating motor adjuster according to claim 1, wherein the second rotor is adapted to be oscillated as a function of the first rotor.

3. The oscillating motor adjuster according to claim 1, further comprising an electromagnetically adjustable hydraulic valve associated with each rotor.

4. The oscillating motor adjuster according to claim 1, wherein the second rotor is disposed inside the first rotor in the same plane.

5. The oscillating motor adjuster according to claim 4, wherein the first rotor is designed as an intermediate rotor, from the inside of which inner crosspieces project radially inward.

6. The oscillating motor adjuster according to patent claim 5, wherein the inner crosspieces are formed in one piece with the intermediate rotor.

7. The oscillating motor adjuster according to claim 1, wherein the stator is mounted in a rotatable manner in a housing borehole of a housing, whereby oil can be conducted through recesses in a stator outer wall into pressure chambers assigned to opposite oscillating directions.

8. The oscillating motor adjuster according to patent claim 7, wherein a region of the stator projects out from the housing borehole, the region being joined to a gearing in a movement-resistant manner.

9. The oscillating motor adjuster according to patent claim 8, wherein the gearing is disposed on a side of the oscillating motor adjuster facing the camshaft.

10. The oscillating motor adjuster according to claim 7, wherein oil is transferred from the housing to the recesses via annular encircling channels.

11. The oscillating motor adjuster according to claim 1, further comprising:
a component provided inside a rotor hub of the second rotor, the component adapted to conduct oil coming from a housing to pressure chambers of the second rotor.

12. The oscillating motor adjuster according to patent claim 11, wherein the component is pin-shaped and faces the second rotor.

13. The oscillating motor adjuster according to claim 1, further comprising a central screw inside a rotor hub which axially braces the second rotor with the camshaft.
